(19) United States
(12) Patent Application Publication
(10) Pub. No.: US 2015/0254588 A1
(43) Pub. Date: Sep. 10, 2015

(54) MANUFACTURING COST ESTIMATOR

(71) Applicant: aPriori Technologies, Inc., Concord, MA (US)

(72) Inventors: Constantine Kozhukhin, Acton, MA (US); Eugene Gorokhovsky, Arlington, MA (US); Julie A. Driscoll, Weston, MA (US); William Tam, Lexington, MA (US)

(73) Assignee: aPriori Technologies, Inc., Concord, MA (US)

(21) Appl. No.: 14/281,148

(22) Filed: May 19, 2014

Related U.S. Application Data
(63) Continuation of application No. 14/200,633, filed on Mar. 7, 2014.

(51) Int. Cl. G06Q 10/06; G06F 17/50

(52) U.S. Cl. CPC G06Q 10/06313; G06F 17/50

(57) ABSTRACT

Computer-based methods and systems are provided for improved recognition and presentation of parts, such as machine parts, as well as methods and systems for modeling and predicting the cost of such parts.

### CROSS-REFERENCE TO RELATED APPLICATIONS

This application is a continuation of the following U.S. patent application, which is hereby incorporated by reference in its entirety: U.S. patent application Ser. No. 14/200,633 filed Mar. 7, 2014.

### BACKGROUND

1. Field

The present disclosure is generally related to devices and methods for automatically facilitating cost estimation of manufactured components and assemblies.

2. Description of Related Art

There is an ongoing emphasis on cost reduction in manufacturing. This emphasis on manufacturing cost is being propagated back into the design function with engineers and designers being asked to consider design for cost together with design for manufacturability, design for reuse, and the like. Historically, a designer would create a description of a component such as a drawing or a CAD model and provide the model to a manufacturing engineer, machinist, or the like. The machinist or engineer would map out the steps required to manufacture the piece and provide an estimate of piece cost for manufacturing. This process may be quite time consuming and has the potential to lengthen design time or be eliminated in the interest of maintaining schedule. Recently there have been programs that are designed to assist the design engineer in estimating costs. However, many of these still require the user to enter the manufacturing steps that will be used to create the component. This may be burdensome to a design engineer who may not be trained in manufacturing.

### SUMMARY

In accordance with exemplary and non-limiting embodiments, computer-based methods and systems are provided for improved recognition and presentation of parts, such as machined parts, as well as improved methods and systems for modeling and predicting the cost of such parts.

The present disclosure describes computer implemented methods and systems, including machines for the automatic identification of a gear within a visual representation of a component where the methods and systems involve computer programming to carry out one or more of the steps of: identifying an axially symmetric geometric pattern of the component; analyzing features of the geometric pattern; comparing analyzed features to a rule set; and categorizing the axially symmetric geometric pattern as one of non-gear, internal spur gear, external spur gear, external helical gear, internal helical gears, external spline, internal spline, spiral gear, straight bevel gears, flute, sprocket, and face gear.

Also disclosed are computer-implemented methods and systems, including machines for the automatic estimation of the cost of manufacturing a given number of a specific gear where the methods and systems involve computer programming to carry out one or more of the steps of: identifying manufacturing methods capable of manufacturing the category of the specific gear; identifying equipment capable of manufacturing the gear from a set of available manufacturing machines; estimating the time for making the gear on a particular machine given a model of the equipment capabilities; estimating the cost for making the gear on a particular machine given the time required and a cost model for the manufacturing machine; estimating the cost of any tooling required to make the gear on a particular machine given a cost model for the manufacturing machine; estimating the total cost for making a specified volume of gears on the identified equipment; and providing a user with a per piece cost estimate for the manufacture of the gear.

The present disclosure also describes computer-implemented methods and systems, including machines for the automatic estimation of manufacturing cost for a component given a visual representation of an initial starting component and a final component where the methods and systems involve computer programming to carry out one or more of the steps of: identifying differences between the initial and final component as a set of manufacturable steps wherein each step is categorized; identifying, for each step, a plurality of manufacturing methods capable of manufacturing the step based on its category; identifying equipment capable of identified manufacturing methods from a set of available manufacturing equipment; estimating, for each step, the time required on each piece of equipment identified as capable of manufacturing the identified step given a model of the equipment capabilities; estimating, for each step, the cost of using a particular piece of equipment given the time required and a cost model for that piece of equipment; estimating, for each step, the cost of any tooling required to manufacture that step on a particular machine; aggregating the total costs for each possible combination of manufacturing steps required to produce the set of identified differences; estimating the total cost for making a specified volume of final components on the identified equipment; and providing a user with a per piece cost estimate for the manufacture of the final component from the initial component.

The present disclosure describes computer-implemented methods and systems, including machines for the automatic estimation of the manufacturing cost of an assembly given a scenario specification and a list of subassemblies and components where methods and systems involve computer programming to carry out one or more of the steps of calculating the costs of individual components and subassemblies; calculating the costs of assembling the components and subassemblies; and providing a detailed cost estimation analysis to a user.

The present disclosure discloses a method for automatically estimating a manufacturing cost, the method comprising: identifying a component and a final configuration of the component; identifying differences between the component and the final configuration of the component; determining steps to transform the component to the final configuration of the component; determining at least one process for each of the transformation steps; identifying manufacturing equipment for carrying out the determined at least one process for each of the transformation steps; estimating a time required on each piece of equipment for the at least one process for each transformation step using a model of equipment capabilities for each piece of manufacturing equipment; estimating a cost given the time required for using each piece of manufacturing equipment for each transformation step using a cost model for each piece of manufacturing equipment; estimating a cost of tooling required for each piece of manufacturing equipment for each step for which tooling is required; aggregating a total cost for all the determined processes for all the determined transformation steps; and estimating a total cost for manufacturing a specified quantity of the final configuration of the component. In some cases, the at least one process is a plurality of processes for transforming the component to the final configuration and wherein the step for aggregating the total cost is performed for the each of the plurality of processes and wherein the step of estimating the total cost is performed for each of the plurality of processes. In embodiments, the specified quantity may be selected from the group consisting of a batch, an annual volume, and the like. In embodiments, the initial component may be a beginning configuration of a procured part such as plastic sheetstock, a plastic barstock, a sheetstock, a barstock, a casting, a forging and a blank, a partially completed final component, a subassembly, and the like. In embodiments, a user may be provided with a per piece cost estimate for manufacturing the specified quantity of the final configuration of the component from the component. Estimated time required on each piece of equipment may include a separate estimated time for set up and tear down. The cost model for each piece of equipment may comprise labor costs, overhead costs, real estate costs, computer processing costs, parts costs, allocation of overhead costs, raw material costs, capital costs, rental cost, leasing costs, energy costs, and the like. The model of the equipment capabilities may comprise equipment speed, operator labor required, equipment setup time, equipment range of motion, and the like.

The present disclosure discloses a method for automatically estimating a manufacturing cost for a component, the method comprising: identifying the component via a first 3-D CAD model and a final configuration of the component via a second 3-D CAD model for the final configuration of the component; identifying differences between the component and the final configuration of the component; determining steps to transform the component to the final configuration of the component; determining at least one process for each of the transformation steps; identifying manufacturing equipment for carrying out the determined at least one process for each of the transformation steps; estimating a time required on each piece of equipment for the at least one process for each transformation step using a model of equipment capabilities for each piece of manufacturing equipment; estimating a cost given the time required for using each piece of manufacturing equipment for each transformation step using a cost model for each piece of manufacturing equipment; estimating a cost of tooling required for each piece of manufacturing equipment for each step for which tooling is required; aggregating a total cost for all the determined processes for all the determined transformation steps; and estimating a total cost for manufacturing a specified quantity of the final configuration of the component. In some cases, the at least one process is a plurality of processes for transforming the component to the final configuration and wherein the step for aggregating the total cost is performed for the each of the plurality of processes and wherein the step of estimating the total cost is performed for each of the plurality of processes. In some cases, there may be an intermediate stage for the component, characterized by a third 3-D CAD model wherein the system may determine the steps to transform the first 3-D CAD model to the third 3-D CAD model via at least one manufacturing process. Furthermore, the system may then determine the steps to transform the third 3-D CAD model to the final component via at least one manufacturing process. The first 3-D CAD model may be a gear blank and the second 3-D CAD model may be a finished gear model. In some cases, one of the manufacturing processes may be a molding step and estimating the cost of tooling may comprise a step of determining a draw direction for the tool. The model of the equipment capabilities comprises at least one capability selected from the group consisting of equipment speed, operator labor required, equipment setup time, and equipment range of motion. In some cases, the first 3-D CAD model may be a solid block of material in a shape selected from the group consisting of a square, a cuboid, a cylinder and a hollow cylinder. In some cases, information useful for estimating the manufacturing cost such as available equipment, manufacturing costs, material costs, labor costs, overhead costs, energy costs, and the like may be stored.

The present disclosure discloses a method for automatically estimating a manufacturing cost, the method comprising: identifying a component and a final configuration of the component; identifying differences between the component and the final configuration of the component; determining steps to transform the component to the final configuration of the component; determining at least one process for each of the transformation steps; identifying manufacturing equipment for carrying out the determined at least one process for each of the transformation steps; estimating a time required on each piece of equipment for the at least one process for each transformation step using a model of equipment capabilities for each piece of manufacturing equipment; estimating a cost given the time required for using each piece of manufacturing equipment for each transformation step using a cost model for each piece of manufacturing equipment; aggregating a total cost for all the determined processes for all the determined transformation steps; and estimating a total cost for manufacturing a specified quantity of the final configuration of the component. In some cases, the at least one process is a plurality of processes for transforming the component to the final configuration and wherein the step for aggregating the total cost is performed for the each of the plurality of processes and wherein the step of estimating the total cost is performed for each of the plurality of processes. In some cases a cost of tooling required for each piece of manufacturing equipment for each step for which tooling is required may be estimated. In some cases, estimating the cost of tooling comprises a step of determining a draw direction for the tool. Material for the component may comprise a plastic sheetstock, a plastic barstock, a sheetstock, a barstock, a casting, a forging a partial assembled component, a subassembly, a blank, and the like. In some cases, one transformation step is creating a hole where a computer program for estimating the total cost may comprise at least one routine for estimating a cost of creating the hole, the at least one routine selected from the group consisting of drilling, milling, laser cutting and punching.

The present disclosure discloses a method for automatically identifying a gear within a representation of a component, the method comprising: identifying an axially symmetric geometric pattern of the component; analyzing features of the geometric pattern; comparing the analyzed features to a rule set; and categorizing the axially symmetric geometric pattern as one of a non-gear, an internal spur gear, an external spur gear, an external helical gear, an internal helical gear, an external spline, an internal spline, a spiral gear, a straight bevel gear, a flute, a sprocket and a face gear. The representation of the component may be one of a drawing, a visual computer representation, a CAD model representation, and the like. The features of the geometric pattern may be one of a diameter, a radius, an outer diameter (OD), an inner diameter (ID), an angle, an angle width, a helix angle, a cone angle, a Number of Teeth, a Face Width, a Diametral Pitch, and the like. In some cases, the method disclosed may comprise automatically identifying the axially symmetric geometric pattern as a gear and estimating a cost of manufacturing the gear. Cost of manufacturing may comprise: identifying at least one machine for manufacturing the gear from a set of available machines; estimating a time for manufacturing the gear on the at least one machine given a model of capabilities of the at least one machine; estimating a cost for making the gear on the at least one machine given the estimated time and a cost model for the at least one machine; estimating a cost of tooling required to make the gear on the at least one machine given the cost model for the at least one machine, if any tooling is required; estimating a total cost for making a specified quantity of gears using the at least one machine; and providing a user with an ordered list of per gear estimates for the manufacture of the gear on the at least one machine.

The present disclosure discloses automatically estimating a cost of manufacturing a given number of a specific gear, the method comprising: identifying steps for manufacturing the specific gear based on its category; identifying equipment for manufacturing the specific gear from a set of manufacturing machines; estimating a time on at least one particular machine during manufacturing of the specific gear given a model of capabilities of the at least one particular machine; estimating a cost for making the specific gear on the particular machine given the estimated time and a cost model for the particular machine; estimating a cost of tooling required to make the specific gear on the particular machine given the cost model for the particular machine; and estimating a total cost for making a specified number of gears using the at least one particular machine. In some cases, a user may then be provided with a per piece cost estimate for the manufacture of the specific gear. In some cases, identifying steps for manufacturing the category of the specific gear may comprise the application of rules relating to at least one of the specific gear, an adjacent geometric feature, a quality rating for the category of the specific gear, tolerance requirements, and the like. The cost model for a particular machine may comprise labor costs, overhead costs, real estate costs, computer processing costs, parts costs, allocation of overhead costs, raw material costs, capital costs, rental cost, leasing costs, energy costs, and the like. The model of capabilities of a particular machine comprises may comprise equipment speed, operator labor required, equipment setup time, equipment range of motion, and the like. In some cases, parameters of the specific gear may be automatically identified from a visual representation. In some cases, parameters of the specific gear may be entered manually. In some cases, the cost model for the manufacturing machine accounts for the number of items produced.

The present disclosure discloses a method of automatically identifying a gear and estimating a manufacturing cost of the gear within a representation of a component via at least one computer, the method comprising: identifying an axially symmetric geometric pattern; analyzing features of the axially symmetric geometric pattern; comparing the analyzed features to a rule set of analyzed features; identifying the axially symmetric geometric pattern; if the axially symmetric geometric pattern is a gear, identifying methods for manufacturing the gear; identifying at least one machine for manufacturing the gear from a set of available machines; estimating a time for manufacturing the gear on the at least one machine given a model of capabilities of the at least one machine; estimating a cost for making the gear on the at least one machine given the estimated time and a cost model for the at least one machine; estimating a cost of tooling required to make the gear on the at least one machine given the cost model for the at least one machine; estimating a total cost for making a specified quantity of gears using the at least one machine; and providing a user with an ordered list of per gear estimates for the manufacture of the gear on the at least one machine. The method may further comprise storing information useful for the estimating the manufacturing cost of the gear such as available equipment, manufacturing costs, material costs, labor costs, transportation costs, overhead costs, energy costs, and the like. The step of identifying the axially-symmetric pattern may require identifying the axially-symmetric pattern as an object such as a non-gear, an internal spur gear, an external spur gear, an external helical gear, an internal helical gear, an external spline, an internal spline, a spiral gear, a straight bevel gear, a flute, a sprocket and a face gear. In some cases, the step of identifying the axially-symmetric pattern may require identifying the axially-symmetric pattern as an object such as a non-gear, an internal gear, an external gear, a spur gear and a bevel gear.

The present disclosure discloses a method for estimating a cost for an assembly, the method comprising: identifying a plurality of parts, the parts comprising at least one of components and subassemblies for the assembly; calculating a cost of each identified component; calculating a cost of each identified subassembly; calculating a cost of assembling each of the components and subassemblies requiring assembling; and calculating a total cost of parts and a total cost of assembling for the assembly. In some cases the method may enable a user to develop a plurality manufacturing scenarios for a given assembly and concurrently run cost estimations for the plurality of manufacturing scenarios associated with a given assembly. In some cases, the cost of each identified component may be calculated at each of a plurality of separate manufacturing facilities. In some cases, the cost of each identified subassembly may be calculated at each of a plurality of separate manufacturing facilities. In some cases, the cost may be calculated for assembling each of the components or subassemblies requiring assembly at each of a plurality of separate facilities. The method for estimating the cost may include using an estimated quantity of the assembly where changing the estimated quantity causes a change in the step of calculating a cost of at least one identified component or in calculating a cost of assembling at least one of the components or subassemblies, thus changing the calculated total cost for the changed estimated quantity. The estimated quantity may be one of batch quantity, an annual volume, and the like. In some cases, the system may store information regarding manufacturing and assembly costs for a plurality of components and a plurality of subassemblies useful for the estimating the cost of the assembly such as available equipment, manufacturing costs, material costs, labor costs, transportation costs, overhead costs, energy costs and the like.

The present disclosure discloses a method for estimating a cost for an assembly, the method comprising: identifying a plurality of parts, the parts comprising at least one of components and subassemblies for the assembly; calculating a cost of each identified component, wherein calculating the cost of at least one identified component comprises calculating a cost to manufacture the at least one identified component from a cost of time and materials; calculating a cost of each identified subassembly; calculating a cost of assembling each of the components and subassemblies requiring assembling; and calculating a total cost of parts and a total cost of assembling for the assembly. In some cases the method may enable a user to develop a plurality manufacturing scenarios for a given assembly and concurrently run cost estimations for the plurality of manufacturing scenarios associated with a given assembly. In some cases, the cost of each identified component may be calculated at each of a plurality of separate manufacturing facilities. In some cases, the cost of each identified subassembly may be calculated at each of a plurality of separate manufacturing facilities. In some cases, the cost may be calculated for assembling each of the components or subassemblies requiring assembly at each of a plurality of separate facilities. In some cases, the cost to manufacture may use two-model cost estimation.

The present disclosure discloses a method for estimating a cost for a specified quantity of an assembly, the method comprising: identifying a plurality of parts, the parts comprising at least one of components and subassemblies for the assembly; calculating a cost of each identified component; calculating a cost of each identified subassembly; calculating a cost of assembling each of the components and subassemblies requiring assembling; and calculating a total cost of parts and a total cost of assembling for the particular quantity of the assembly, wherein the total cost includes estimates for the specified quantity of the assembly and wherein the cost of at least one of the identified components, the cost of at least one of the identified subassemblies and the cost of assembling each of the components and subassemblies depends on the specified quantity. In some cases, changing the specified quantity and calculating the total cost of parts and the total cost of assembly for the changed specified quantity requires recalculating at least one cost selected from the group consisting of the cost of an identified component, the cost of an identified subassembly and the cost of assembling at least one component or subassembly requiring assembling. In some cases, the cost to manufacture may use two-model cost estimation. In some cases, at least one identified component is a gear and the cost of the gear is calculated with an automatic gear costing program that includes a step of automatically identifying an axially symmetric geometric pattern. In some cases, at least one identified part is a molded part or a casting and the cost of a tool for manufacturing the molded part or casting is calculated with a program for determining a low-cost draw direction for the tool. In some cases, the specified quantity is a batch quantity, an annual volume, or the like.

The present disclosure discloses a method for determining a draw direction for a component to be made by molding: identify a plurality of possible draw directions; for each of the plurality of possible draw directions, assign a value for a plurality of features selected from the group consisting of: a volume of undercuts along a possible draw direction; a number of holes aligned with the possible draw direction; a number of grilles aligned with the possible draw direction; a number of holes not aligned with the possible draw direction; a number of grilles not aligned with the possible draw direction; an area of surfaces aligned with the possible draw direction; an area of surfaces not aligned with the possible draw direction; a number of mounting holes aligned with the possible draw direction; a part height along the possible draw direction; a vertical height of a parting line along the possible draw direction; and a flatness of a parting line along the possible draw direction for a tool to be used to make the component; sum the values separately of each of the plurality of possible draw directions; and determine the draw direction based on a highest sum. Possible draw directions may comprise cardinal directions and directions aligned with one of more of large surface areas of the component to be made by molding. In some cases, the value of each feature may be normalized to a normalized value between zero and one, inclusive. In some cases, a hole aligned with the possible draw direction may have a higher value than a hole not aligned with the possible draw direction. In some cases, a flat parting line along the possible draw direction may have a higher value than a parting line that is not flat. In some cases, the volume of undercuts may be calculated for each of the possible draw directions and a draw direction with a smaller volume of undercuts may have a higher value than an undercut with a larger volume. In some cases, a higher value may be given to a draw direction having a larger area of aligned surfaces of the component than those of other possible draw directions.

The present disclosure discloses a method for determining a draw direction for a component to be made by molding including the steps of: identify a plurality of possible draw directions; for each of the plurality of possible draw directions, assign a value for a plurality of features selected from the group consisting of: a volume of undercuts along a possible draw direction; an area of surfaces aligned with the possible draw direction; an area of surfaces not aligned with the possible draw direction; a part height along the possible draw direction; a vertical height of a parting line along the possible draw direction; and a flatness of a parting line along the possible draw direction for a tool to be used to make the component; sum the weighted values separately of each of the plurality of possible draw directions; and determine the draw direction based on a highest sum. In some cases, the value of each feature may be normalized to a normalized value between zero and one, inclusive. In some cases, the normalizing values for the features may be adjusted based on empirical results. In some cases, the normalizing values may also serve as weights to adjust for the relative importance of such features as the volume of undercuts along the possible draw direction and for the area of surfaces aligned with the possible draw direction. In some cases, a flat parting line along the possible draw direction may have a higher value than a parting line that is not flat. In some cases, the volume of undercuts may be calculated for each of the possible draw directions and a draw direction with a smaller volume of undercuts may have a higher value than an undercut with a larger volume. In some cases, a higher value may be given to a draw direction having a larger area of aligned surfaces of the component than those of other possible draw directions. In some case, a hole aligned with the possible draw direction has a higher value than a hole not aligned with the possible draw direction. Possible draw directions may comprise cardinal directions and directions aligned with one of more of large surface areas of the component to be made by molding.

### BRIEF DESCRIPTION OF THE FIGURES

The disclosure and the following detailed description of certain embodiments thereof may be understood by reference to the following figures:

FIG. 1 shows an automatic cost estimation system.

FIG. 2 shows a routing rules table comprising categories of manufacturable features and corresponding manufacturing processes.

FIG. 3 shows an example of a final manufactured component and possible starting blanks.

FIG. 4 shows an initial casting, two views of the final component and a visual representation of the differences between the two.

FIG. 5 shows an example of a CAD model with both accurately modeled gears and symmetrical surfaces.

FIG. 6 shows an example of a user interface dialog where gear parameters may be entered or altered.

FIG. 7 shows a gear manufacturing rule matrix.

FIG. 8A shows an external gear.

FIG. 8B shows an external gear with adjacent geometry.

FIG. 8C shows an internal gear.

FIG. 8D shows an internal gear with adjacent geometry.

FIG. 9 shows an illustration of an external gear together with a hobbing tool.

FIG. 10 shows a rules table relating gear quality specification and gear manufacturing methods.

FIG. 11A shows a screenshot of an input screen showing a top level assembly and underlying subassemblies.

FIG. 11B shows a screenshot of an input screen showing a top level assembly and underlying subassemblies.

FIG. 11C shows an example of a copied scenario with the initial input values reflecting the original values.

FIG. 12A shows a screenshot of an input screen where a change in volume has been made to the top level assembly.

FIG. 12B shows a screenshot of a user input screen where change in volume at the top level assembly have been propagated to the underlying components and assemblies.

FIG. 13A shows a screenshot of a user input screen with an option to “Deep Cost Scenario.”

FIG. 13B shows a user input screen comprising details for a top level assembly such as sub assemblies and components and means for a user to specify attributes.

FIG. 14A shows an input screen comprising information regarding a specific scenario with a drop down menu enabling the user to select an option of “deep cost all scenarios.”

FIG. 14B shows a user input screen showing details for a plurality of scenarios.

FIG. 15A shows a user input screen showing the selection of an assembly's subassembly and a drop down menu option to “switch scenario.”

FIG. 15B shows a user input screen illustrating a top-level scenario having a subassembly with an alternate scenario.

FIG. 16 shows a spreadsheet where columns may comprise options representative of those accessible from the user screens accessed through deep costing.

FIG. 17 shows a part to be analyzed for selection of draw direction.

### DETAILED DESCRIPTION

An embodiment according to the disclosure may be implemented in the context of an automated costing system of the type described in U.S. Patent Application Publication No. 2005/0120010 A1 of Philpott et al., published Jun. 2, 2005, entitled “System and Method for Determining Costs within an Enterprise,” the entire contents of which are incorporated herein by reference.

An embodiment according to the disclosure may be implemented in the context of a process routing template of the type described in U.S. Patent Application Publication No. 2011/0130855A1, published Jun. 2, 2011 entitled “Template Framework for Automated Process Routing,” the entire contents of which are incorporated herein by reference.

In embodiments, there may be an automatic costing system for estimating the cost of manufacturing an object such as a component, part, assembly, multiple parts, multiple assemblies, and the like, when provided with a visual representation of the component or assembly such as a drawing, Computer Aided Design (CAD) model of the component, and the like. References to “parts” in this disclosure should be understood to refer, except where context prevents, to all such types of items. In embodiments, the system may analyze the model and identify and categorize a set of manufacturable features in the model such as holes, pockets, flat surfaces, single or multi curved surfaces, rings, cylinders, and the like, that, as a set, fully describe the component. These in turn may be used to determine a set of cost drivers for the manufacturable component. The cost drivers may be used in computer-implemented mathematical equations to determine the cost of manufacturing the component. For example, the cost drivers might include the number of small holes and bends in the component, or the perimeter of the component. These features “drive” the cost and may be used by the system to calculate, for example, cycle times and incentive times that determine costs. In some cases, the number of features is the cost driver (such as number of holes, edges, and different types of bends, etc.), and in other cases, measurable parameters of the feature may be a cost driver (such as perimeter length, part volume surface area, etc.). In the costing system, feature extraction algorithms may distinguish true manufacturing features—that is, features that directly affect cycle time and cost computation. For example, “small holes” are holes less than 5 mm in diameter, the size below which a laser needs to make a step change in cut speed. As another example, the feature extracting algorithms might identify collinear “bends” that can be completed by one action of a bend brake.

In embodiments, there may be a plurality of rule sets describing which manufacturing processes are capable of creating a given category of manufacturable feature, equipment capabilities, cost structures and the like. These rule sets may be used to select possible manufacturing paths, manufacturing time required on different pieces of equipment and estimated costs.

A process routing template framework may provide a language for specifying possible manufacturing paths or process routings as a set of trees. Each node in a process routing tree represents an individual process. A process may further decompose into a sequence of sub-processes, in which case the process would be represented as a branch node in the tree. The language used to define these trees is referred to as the Process Routing Template Specification Language. A program written in this language is referred to as a Routing Template Specification. Each line in a specification defines a process and the rules used to expand that process into a list of sub-processes. The process definitions in a template specification are recursive. In this way, a plurality of routing trees may be produced for each possible manufacturing path capable of producing the set of manufacturable features that define the component. As part of this phase, the feasibility of each node in the template is evaluated in a depth-first fashion. If a node is found to be infeasible according to the rules supplied by the cost model, the portion of the template rooted at that node is discarded from further analysis.

A detailed cost estimate for each of the generated routing trees may then be calculated. The cost of a routing tree may be calculated by performing a post-order traversal of the tree, meaning that the costs of a node's children are computed prior to computing the cost of the node itself. In this way, the cost of a process may be derived from the costs of its sub-processes. Once the total cost of each tree has been computed, the lowest cost result is selected and presented to the user. The user may override this selection and choose to cost any subset of the trees defined in the template specification.

In embodiments, it may be possible to produce cost estimation comparisons to facilitate insight into the impact of changes in component design, manufacturing facility, manufacturing volume, cost from a supplier and the like. In embodiments, cost estimates may be presented as a percentage of target cost for a component. In embodiments, cost estimates may be presented at various levels of specificity such as time and material only, time and material plus amortized equipment investments, fully burdened cost estimates and the like. In embodiments, cost estimates may be broken down into contributory costs such as material costs, labor costs, direct overhead, amortized batch setup, logistics, periodic overhead allocations, margin, amortized capital investments and the like.

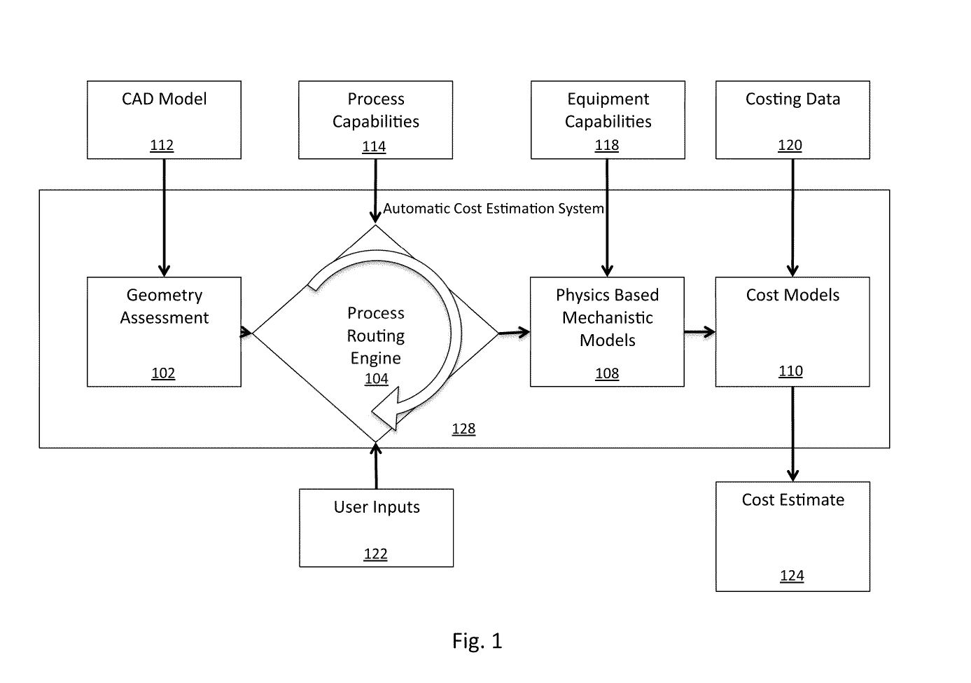

Referring to FIG. 1, a high level flow diagram 100 is shown comprising an automatic cost estimation system 128 and inputs to the system comprising a CAD model 112, process capabilities 114, manufacturing capabilities 118, costing data 120, and user input 122. The automatic cost estimation system 128 comprises geometry assessment 102 of the CAD model 112. Upon identification of categorized manufacturable steps, this information is sent to a process routing engine 104, which utilizes process capabilities 114 to determine potential manufacturing equipment for individual steps and combinations of manufacturing machines and steps such that a plurality of routing trees may be produced for each possible manufacturing path capable of producing the set of manufacturable steps that define the component. The categorized manufacturable steps are then sent to the physics based mechanistic models 108 which utilize information regarding equipment capabilities 118 to model the steps, time, and new tooling that might be required to manufacture a given step on that machine. The information from the physics based mechanistic models 108 is combined with costing data 120 in cost models 110 to generate a cost estimate 124. In embodiments, the CAD model 112, may comprise design data such as design geometry, complexity, material properties, size, weight, tolerances, surface finish and the like. In embodiments, process capabilities 114 may comprise process capability and routing rules such as machine feasibility constraints, material feasibility rules, routing rules, geometric cost driver (GCD) relationship rules, available process selections, available routing selections, and the like. In embodiments, equipment capabilities 118 may comprise information such as equipment speeds and feeds, machine size limits, time standards, tool wear/life information, material physical properties, material stock form and sizes, physical and time model configurable selections, power or energy consumption, and the like. In embodiments, cost data 120 may comprise material cost rates, labor rates, direct and period overhead rates, real estate rates, cost per square foot for factories, machine costs, tool library costs, cost model configurable selections, and the like. In embodiments, user data 122 may comprise information such as material, process group (such as sheet metal, casting, and the like), desired volumes per year, length of product life cycle in years, batch size, preferred manufacturing site, and the like.

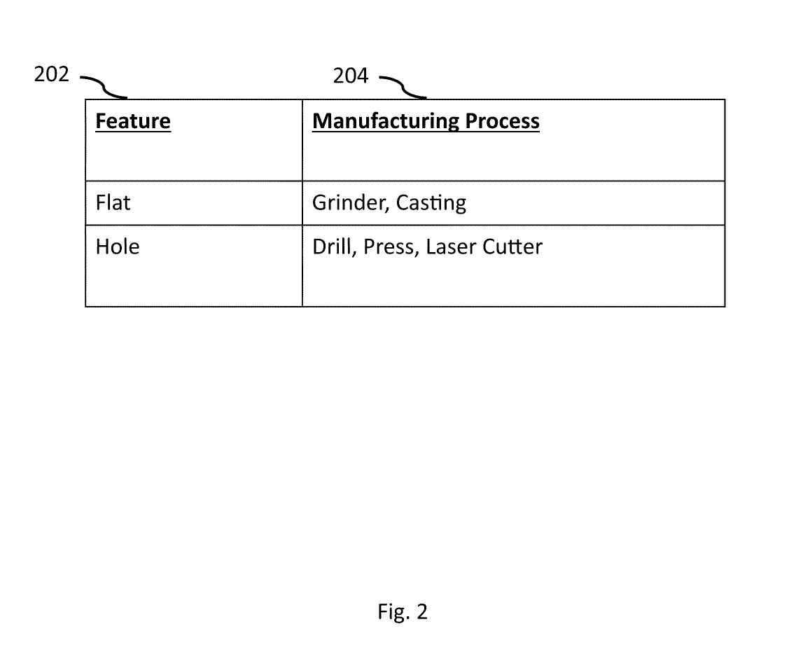

Referring to FIG. 2, an illustrative and non-limiting example of a routing rules set 200, such as might be included in process capabilities 114, is shown comprising categories of manufacturable features 202 and corresponding manufacturing processes 204 capable of manufacturing a given feature. In embodiments, the physics-based mechanistic models 108 may comprise a plurality of algorithms such as: determining which orientations of the blank may be best suited for the manufacture of a step on a specific piece of equipment; determining draw direction for plastic molded and cast or forged parts so as to facilitate ease of hold and reduced cost; simultaneous feature assessment of slide geometry and lifters for tooling to determine whether a single mechanism may be used for both; simultaneous assessment of forms that are made on a press to determine whether two or more forms may be made simultaneously; tracking geometric tolerances across the routing; time required to make a part on a given piece of equipment given material and equipment capabilities; and the like. In an illustrative and non-limiting example, tracking geometric tolerances across the routing may comprise the recognition that a hole with a tight tolerance, if drilled in sheet metal, may require additional refinement in machining to meet the tolerance requirements.

In embodiments, there may be a plurality of virtual production environments, VPEs, from which the user may choose. A virtual production environment may comprise a plurality of information. Much of this information is described in process capabilities 114, manufacturing capabilities 118, costing data 120, with inputs such as: available equipment including capabilities, speeds, cost structure, power or energy consumption, and the like associated with each machine; local labor costs; overhead costs; local material costs; power or energy costs; and the like. In embodiments, the system may come with generic VPEs comprising base process capabilities 114 and manufacturing capabilities 118 for typical types of equipment such as presses, 3-Axis and other milling machines, drills, lathes, laser cutters and the like. In embodiments, the system may comprise sample costing data 120 representative of different regions of the world such as United States, Europe, Latin America, China, Asia, and the like. In embodiments, there may be means for a user to enter process capabilities 114, manufacturing capabilities 118 and costing data 120 representative of their real world facilities, equipment and cost structures.

In embodiments, simulations for each possible manufacturing path may be generated and a set of calculations may occur for each identified manufacturable feature identified in the component for which cost is to be estimated comprising: (1) identify manufacturing process capable of manufacturing the feature; (2) identify available equipment in the virtual production environment (VPE) capable of that manufacturing process; (3) identify relationships between the identified manufacturable features such as whether they may be made on the same equipment, with the same setup and the like; (4) model the process of manufacturing a given feature on that machine including one or more of setup, equipment passes required, any new tooling requirements, time required given material and equipment properties, and the like and calculate time required for the manufacture of that feature; (5) calculate labor costs and machine costs associated with the time required as calculated in the previous step; (6) repeat the process for each manufacturable feature for each possible manufacturing process; and (7) calculate total costs associated with manufacturing the complete component for the each of the different combinations capable of resulting in the final component.

In embodiments, the automatic costing system may default to selecting a manufacturing path such that all operations occur within one virtual production environment. In embodiments, the automatic costing system may be configured such that secondary operations such as heat treatments and surface treatments are not constrained to the virtual production environment at which the component is formed.

In embodiments, the results of the cost estimation analysis may be displayed as a list, a table, a tree of contributory costs, and the like. In embodiments, a visual representation of the part or assembly may be shown where the different manufacturing steps or components are color-coded such as by cost of component or assembly, manufacturing time, complexity, and the like. This may facilitate insight into key drivers of cost, time, and the like.

In embodiments, the automatic costing system may be implemented as a system, such as a machine where the machine is programmed to carry out one or more of the steps described above. In embodiments, the automatic costing system may comprise a non-transitory computer readable medium with an executable program stored thereon, wherein the program instructs a microprocessor to perform the steps described above. In embodiments, the automatic costing system may be a stand-alone machine. In embodiments, the automatic cost estimation system may comprise a plug-in available to existing CAD modeling software that allows cost estimations to be updated from within the CAD modeling system to facilitate easy insight into the cost impact of small design changes. In embodiments, the methods and systems disclosed herein may take a data structure embodied in a non-transitory medium, reflecting the physical structure of a component, such as a machine part, and may operate on the data structure, using it to produce a data structure the represents additional information about the component, including manufacturing and cost information. The additional information may be stored in a data structure in a non-transitory medium.

In traditional costing systems, a user may be required to fully specify the manufacturing path for a component, individually identifying each piece of equipment and all the associated steps involved in manufacturing the components. In embodiments, the system of this disclosure may automatically generate a final manufacturing path where the path is identified based on configurable parameters such as lowest total cost, fastest throughput, and the like. In embodiments, a user interface may be provided that may enable a user to modify the automatically identified manufacturing process to use different equipment, setups, new orientations, select certain surfaces and how they are to be machined, ordering of steps, and the like. In embodiments, the identification of the final manufacturing path may be partially automated where the manufacturing of simple manufacturable features are automated and more complex features are displayed to a user who may have the option of selecting the manufacturing process, equipment, setup, speed, tool, and the like. Thus, in this embodiment, the ease of automation may be combined with accessing the real world expertise of the user.

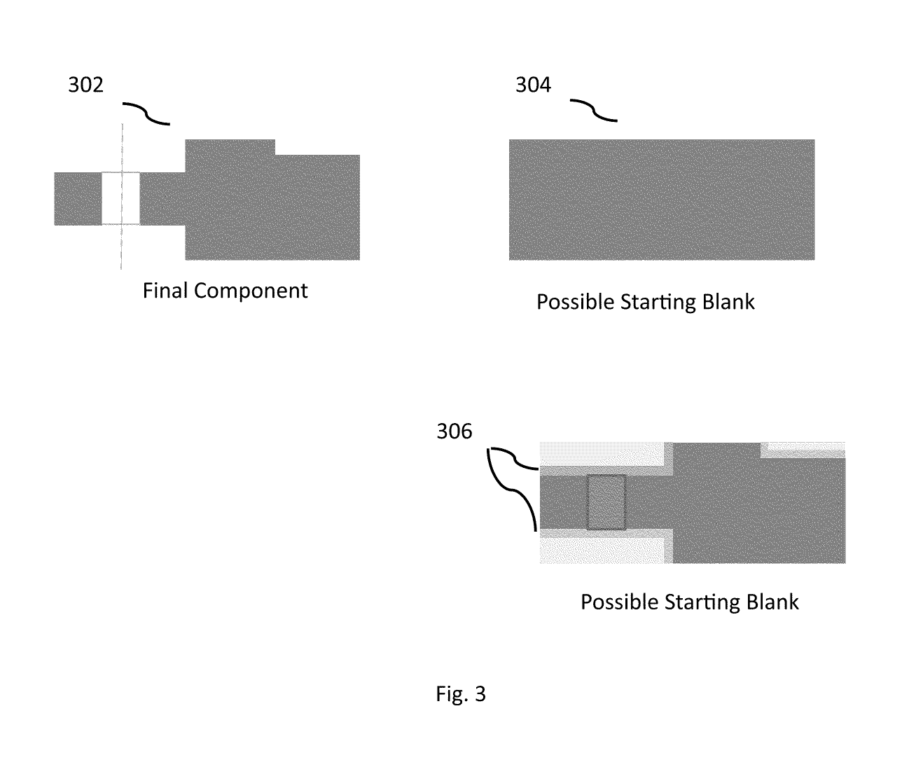

In embodiments, if the cost estimator is provided with only the 3D model for the final finished component, it may be necessary to make an assumption about the size and dimensions of the starting component, blank, from which the final component is manufactured. In an illustrative example, FIG. 3 shows an example of a final manufactured component 302 and possible starting blanks. The final manufactured component 302 may be manufactured from a solid block of material 304 that encompasses the size of the final manufactured component 302. In another approach, a configurable amount of add back material 306 may be added to the exterior of a final manufactured component 302. In both of these approaches, an estimate of the size and dimensions of the starting blank may be created. If this estimate does not accurately reflect the initial starting component, the estimated cost for the final manufactured component 302, which may be reflective of the initial material cost, and the amount of labor required to transform the initial starting component to the final manufactured component 302, and the like, may have significant error. The cost of the final manufactured component 302 would be significantly different if the starting component was represented by the solid block of 304 compared to the small added back material of 306. Significantly less starting material and manufacturing time would be required to create the final manufactured component 302 from a blank containing small amounts of added back material 306 compared to a solid starting blank 304.

In embodiments, it may be possible for the system to use a two-model approach to estimation where the system may identify the differences between an initial CAD model and a final CAD model. This may allow a more accurate starting point than estimating the initial configuration. Most CAD systems are capable of identifying differences between two models in terms of the presence or absence of material between the two different models. However, in embodiments, the system may identify and categorize the differences between the two inputs as a series of specific, categorized, manufacturable features.

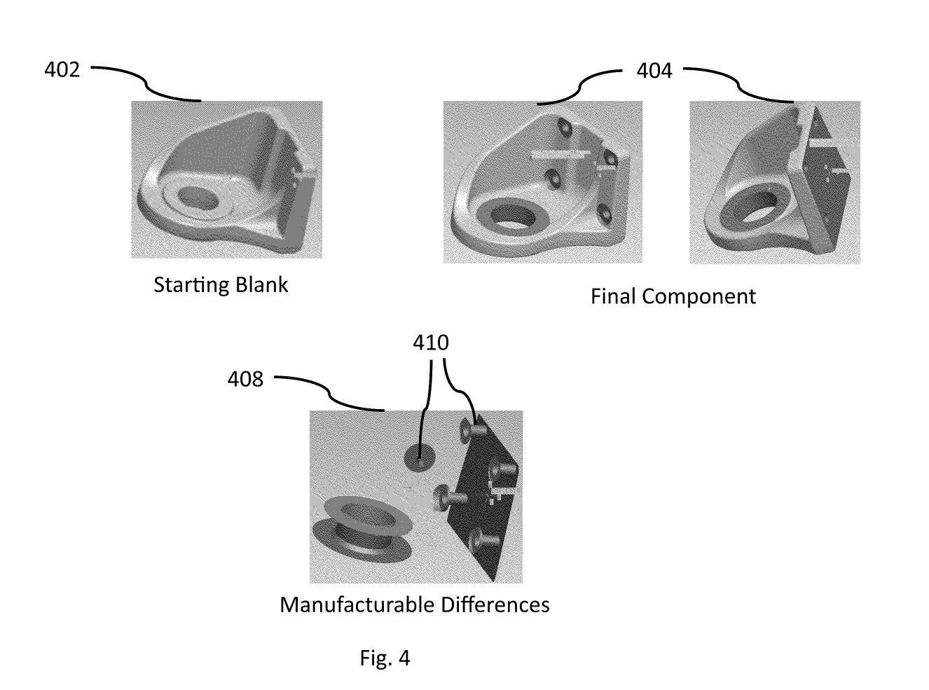

Referring to FIG. 4, an example is shown of an initial casting 402, two views of the final component 404 and a visual representation of the differences between the initial casting 402 and final component 404 shown as a set of specific, categorized, manufacturable features 408. In an illustrative and non-limiting example, the absence of material in the center of a piece may be identified as a hole 410. As described above, there may be a set of rules which define the different manufacturing processes by which a hole may be created such as drilling, press, laser cutter, and the like. In embodiments, there may be detailed model of a virtual production environment comprising information such as material costs, labor costs, available equipment, capabilities of available equipment such as capacity, speed, and the like. From this information, a cost estimate for the manufacturing of the identified hole may be calculated for any of the available manufacturing processes capable of creating a hole.

In embodiments, the use of a two model approach to costing may facilitate accuracy in the final cost estimation model. The cost of the initial component, such as a casting, may be provided as the material cost to the cost estimation of the final component. More accurate information about the geometry of the initial component or blank may facilitate estimates of the amount of material to be removed, the amount of time required to remove the material, and the like. In embodiments, if the surfaces in the final component and the initial blank are close to being coincident it may be assumed that the surfaces are the same and no manufacturing process need be assigned to that surface.

In embodiments, cost estimates may be daisy chained together with the cost estimation for an intermediate component being used as the material cost for a later cost estimation building where the intermediate component is the initial component in a two model approach to costing. Multiple intermediate cost estimations may build upon one another to generate a final cost estimate. In an illustrative and non-limiting example, a series of solid models representing N stages of a manufacturing process may be developed. An estimate of the cost of the initial stage, for example the cost of a casting, may be calculated. The solid model of the casting, together with the estimate of its cost of manufacture, may then be used as input to a 2-model cost estimation for the cost of a stage 2 intermediate component. The cost estimate for the stage 2 intermediate component may then be used as an input to the cost estimation of a stage 3 intermediate component. Thus the cost estimation for a final product may be build up from the cost estimations of a plurality of intermediate components.

In embodiments, it may be possible to identify a gear as a component of a CAD model. In embodiments, for example, axial symmetric repeating patterns of geometry in the model are identified as possible gears. Further analysis may be done to distinguish possible gears from other symmetrical components such as fans, propellers, and the like. Geometric properties may be further assessed to determine, if it is a gear, what type of gear it is. The analysis may comprise evaluation of additional geometric features of the axial pattern such as diameter, radius, outer diameter (OD), inner diameter (ID), angle width, helix angle, cone angle, Number of Teeth, Face Width, Diametral Pitch, and the like. From this analysis, identified gears may be categorized by type such as external and internal spur gears, external and internal helical gears, external and internal splines, spiral and straight bevel gears, flutes, sprockets, face gears, and the like.

In some CAD models gears may be modeled in low resolution or not fully modeled. In some CAD models the geometry may be accompanied by a text description of a gear to be applied to a given cylindrical or conical surface. In some CAD models, the geometry may have one tooth modeled and accompanying text describing the repetition of that tooth to create a complete gear. In embodiments, it may be possible for a user to indicate a cylindrical or conical surface in the CAD model and indicate the presence of a user-defined gear and enter manually enter gear properties. In embodiments, the gear properties may be entered using a gear definition user interface dialog in a CAD model. In embodiments, it may be possible to edit the gear geometry automatically derived from the CAD model.

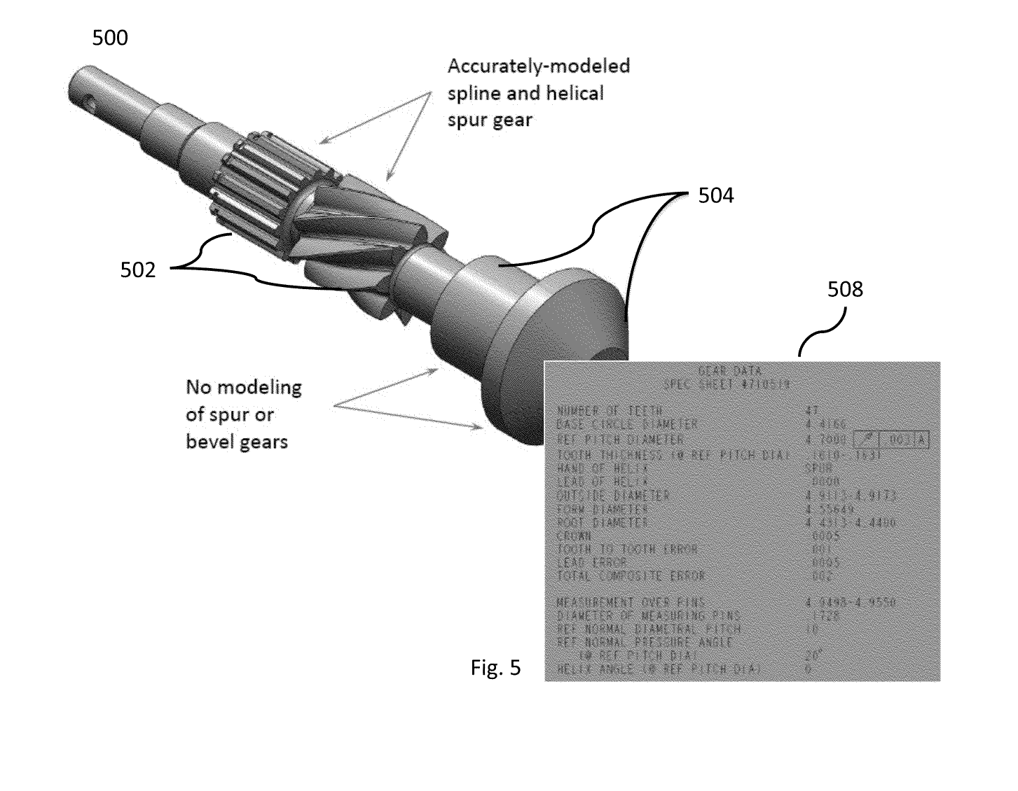

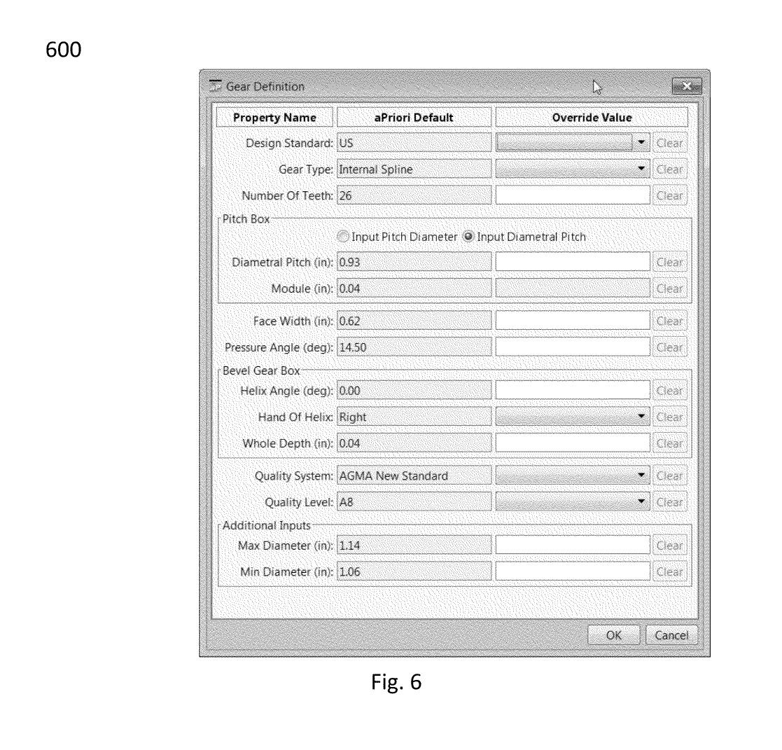

Referring to FIG. 5, an example of a CAD model 500 is shown with both accurately modeled gears 502 and symmetrical surfaces 504 accompanied by a description of the gear 508 to be added to the symmetrical surfaces 504. Referring to FIG. 6, an example of a user interface dialog 600 is shown where gear parameters may be entered or altered.

In embodiments, once a gear has been fully specified, either automatically extracted from the CAD geometry, entered by a user, or a combination thereof, it may be categorized by type such as external and internal spur gears, external and internal helical gears, external and internal splines, spiral and straight bevel gears, flutes, sprockets, face gears, and the like. The categorization may be based on a set of rules relating the value of gear parameters such as whether the gear is on the outside or inside of a feature, the total twist angle of a helix, cone angle degree, whole tooth depth, diametral pitch, teeth/inch, helix angle, and the like.

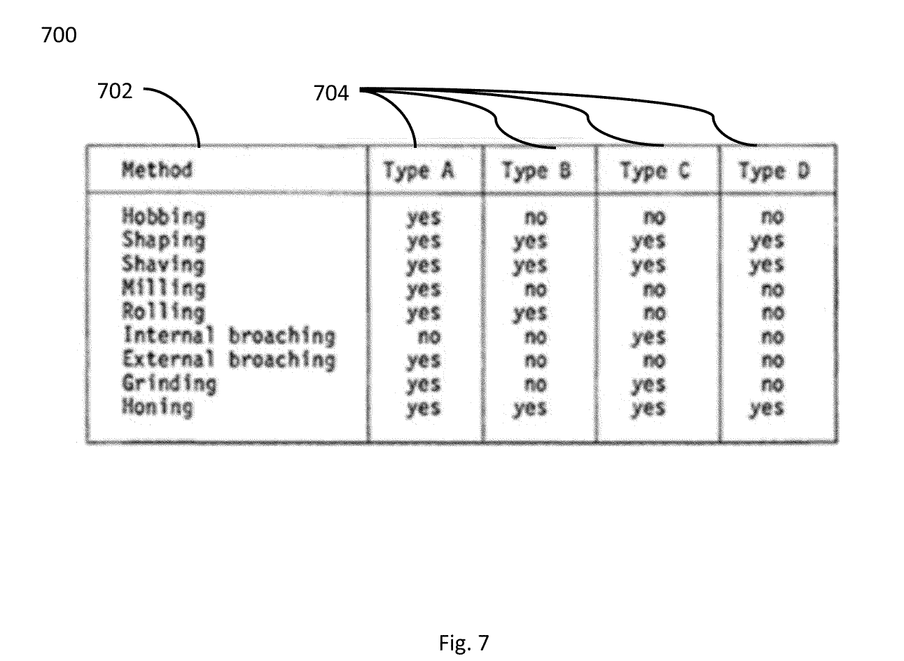

In embodiments, once a gear has been categorized by gear type, a set of rules may be applied to identify potential manufacturing methods by which a specific gear type may be made. Manufacturing processes may comprise casting, forging, hobbing, broaching, shaping, spline rolling, conjugate face milling, shaving, gear grinding, and the like. Referring to FIG. 7, a non-limiting example of a gear manufacturing rule matrix 700 is shown listing gear manufacturing processes 702 and their suitability for different gear types 704.

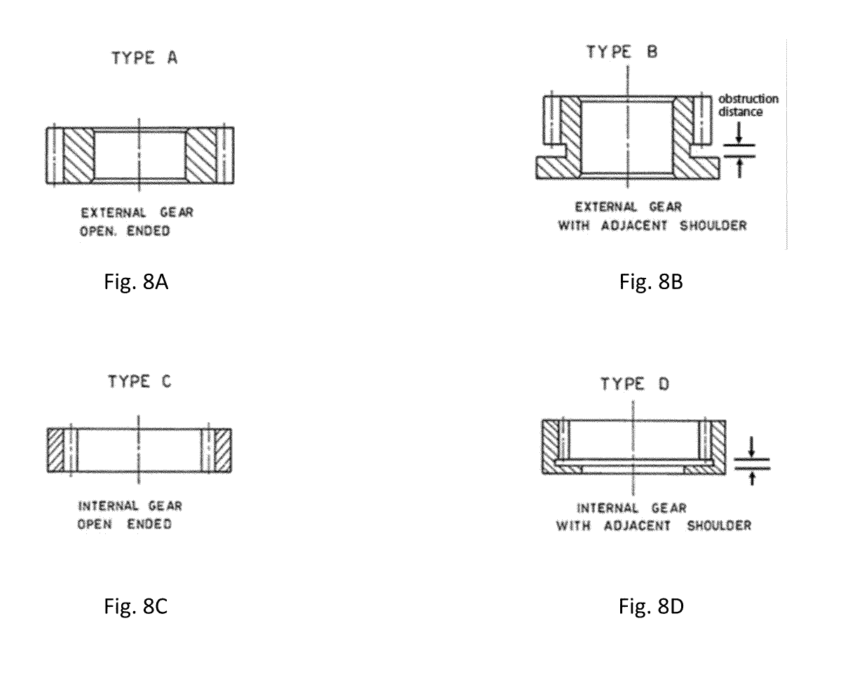

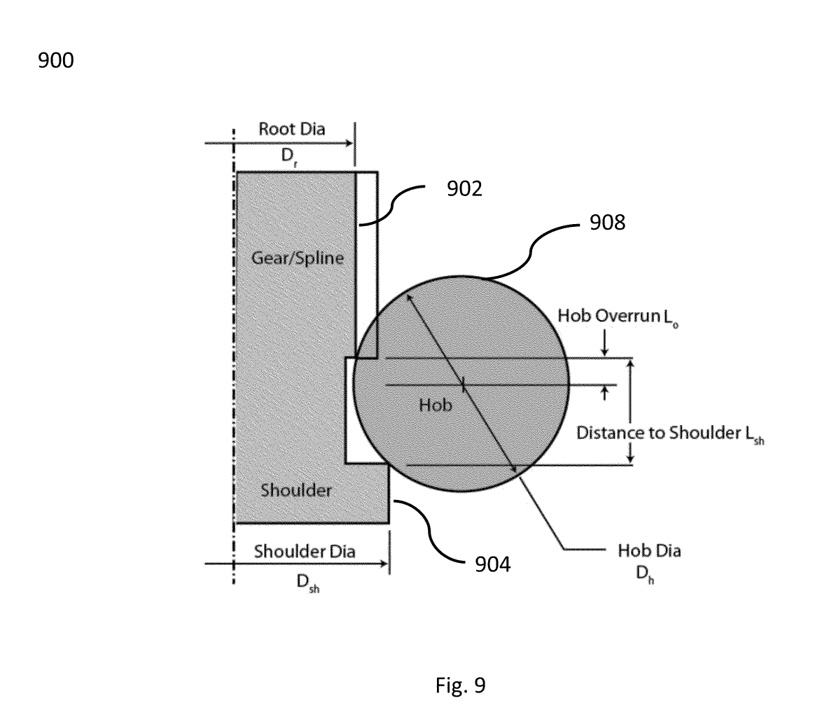

In embodiments, the identification of possible gear manufacturing processes may be further refined with additional information from the CAD model such as surrounding features which may limit gear accessibility and prevent the use of certain machining tools. Referring to FIG. 8A-FIG. 8D, models of different gear types and adjacent geometry are shown. FIG. 8A shows an external gear, open-ended, with no adjacent geometry that may limit machine access to the intended gear. FIG. 8B shows another external gear. However, the gear in FIG. 8B has an adjacent shoulder which, depending on the obstruction distance, may eliminate the ability to use certain techniques in the manufacturing of that gear. Similarly, FIG. 8C and FIG. 8D show examples of an internal gear with and without adjacent geometry having the potential to limit access. The presence of closely adjacent features may limit the ability to use certain types of manufacturing processes, such as broaching, hobbing, and the like, where the process requires “runout.” The process may be determined to be infeasible if an adjacent feature is so close as to block access by the tool. Referring to FIG. 9, an illustration of an external gear 902 with an adjacent shoulder 904 is shown together with a hobbing tool 908. From the illustration shown in FIG. 9, the impact of adjacent geometry on the feasibility of manufacturing method may be seen.

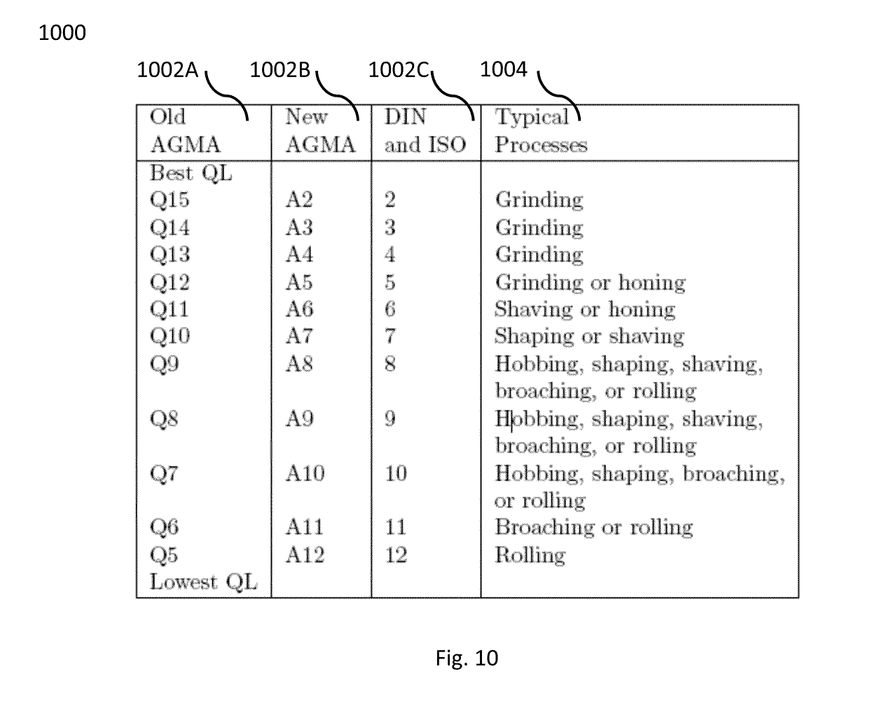

In embodiments, the identification of possible gear manufacturing processes may be further refined by the presence of additional information regarding final gear quality requirements, and the like. Referring to FIG. 10, a rules table 1000 is shown relating gear quality specification 1002A-C and gear manufacturing methods 1004 is shown. The American Gear Manufacturing Association, AGMA, has developed standards for gear quality specifying different diametral pitch range, tooth-to-tooth composite tolerance, total composite tolerance, and the like for gears of different gear pitch diameters and number of teeth. In an illustrative and non-limiting example shown in FIG. 10, a gear with a low quality number (ex. Q5), such as for a toy car, may be adequately manufactured by rolling, a process which shapes teeth by rolling them under high pressure with a toothed die. Material is not actually removed with this method, but rather displaced. A gear with high quality number (ex. Q15), such as for an implantable medical device, may need to be ground to achieve the requisite tolerances.

In embodiments, once the appropriate manufacturing methods have been identified for a gear it may be possible to estimate the cost of manufacturing the gear as described above herein.

Manufacturing companies may have a plurality of manufacturing facilities around the world with each facility having the potential for a unique combination of equipment and cost structure. In embodiments, it may be possible to compare the cost implications of multiple manufacturing scenarios where each scenario may comprise a set of attributes such as where manufacturing occurs, where finishing occurs, where assembly occurs, distributed manufacturing across multiple facilities, and the like. In embodiments, the system of this disclosure may be able to quickly provide comparisons of the cost of individual components, the cost of subassemblies, final product, and the like, between the different scenarios specified. In embodiments, manufacturing scenarios may be include models of future or proposed equipment or manufacturing facilities. In this way, the cost estimation comparisons may provide insight into business decisions regarding investment in new equipment and facilities.

In embodiments, automatic estimation of cost may be extended beyond an estimation of a single component to an estimation of cost for items such as an assembly, an assembly of assemblies, a Bill of Materials (BOM) that describes an entire product, and the like. In embodiments, the estimated costs for individual components may be aggregated together with an estimation of the cost for assembling the individual components into assemblies, the cost of assembling a plurality of assemblies, and the like, to automatically deliver an estimate of the complete cost for an assembly, product, Bill of Material, BOM, and the like.

In embodiments, it may be possible to build a costing scenario for an assembly comprising multiple components, subassemblies, and the like where a scenario may comprise estimating costs for the assembly given a set of inputs such as virtual production environment (VPE), annual volume, production life, batch size, and the like. In embodiments, a scenario may comprise links to a plurality of CAD files representing individual components or assemblies in such a way that updates in a linked CAD file may be reflected in future cost estimates. In embodiments, it may be possible to create one or more copies of an existing scenario where each copy may comprise information about the top level assembly as well as all underlying components and assemblies. In embodiments, the copied scenario may be fully active and capable of processing updates to inputs such as virtual production environment, volume, batch size and the like and generating new cost estimates. Estimates from the original scenario and the copied scenario(s) may be compared and the cost implications of changes easily observed.

In an illustrative and non-limiting example, a manufacturing company may have 3 facilities and wish to estimate the cost of manufacturing a given product or subassembly at each of the faculties. A scenario comprising all the components, subassemblies, volumes and the like may be built up for one of the facilities. After the scenario is completed, two copies may be made and each scenario copy updated to reflect a virtual production environment representative of a different one of the manufacturing facilities. Thus, in this example, enabling an easy comparison of the estimated cost of manufacturing at different facilities. In an illustrative and non-limiting example, copies of a scenario may be made to estimate cost differences associated with different volumes, cost differences associated with different manufacturing processes during assembly of a given component, and the like.

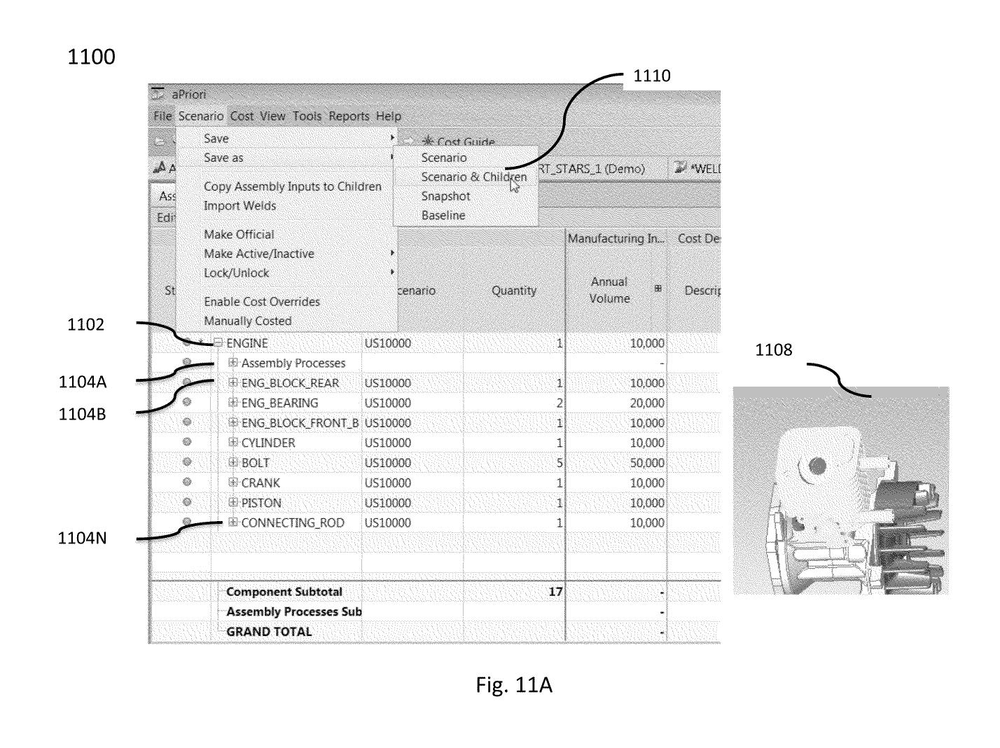

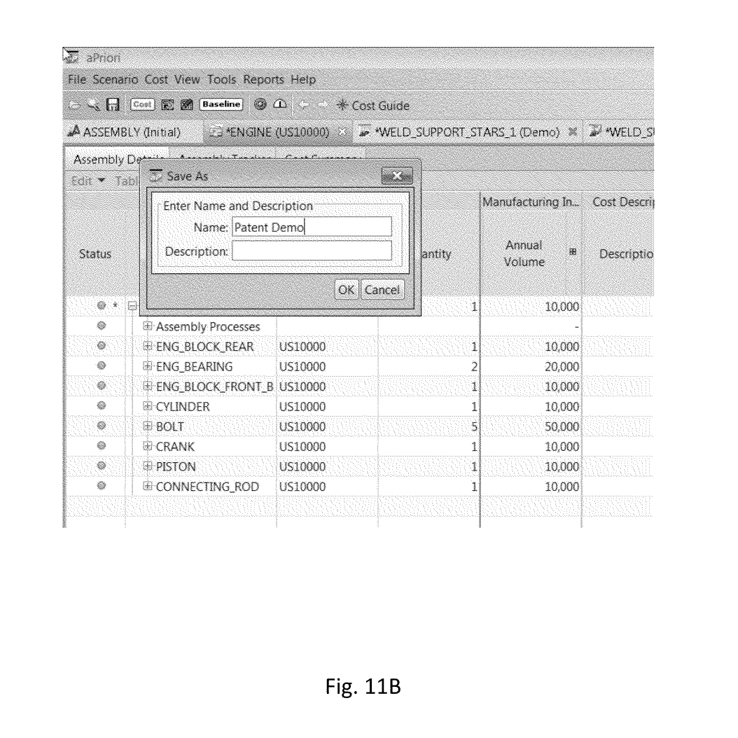

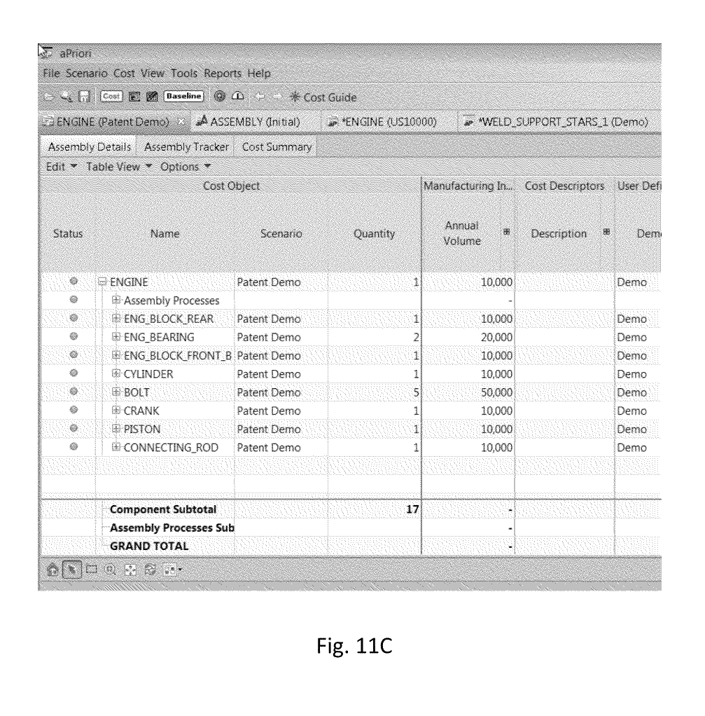

Referring to FIG. 11A, a screenshot of an illustrative example of an input screen 1100 is shown illustrating a CAD representation of an assembly 1108, a list showing the top level assembly 1102 and subassemblies 1104A 1104B 1104N. There is an option to save a copy of this scenario plus children 1110. FIG. 11B illustrates providing a new name for the copied scenario and FIG. 11C shows the copied scenario with the initial input values reflecting the original from which it was copied.

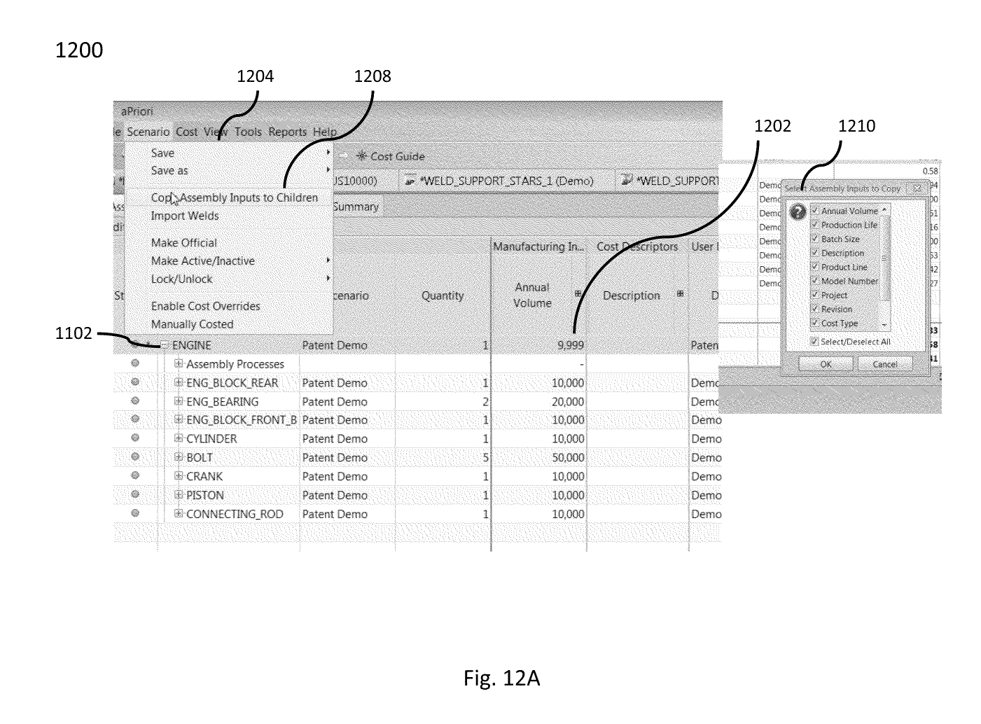

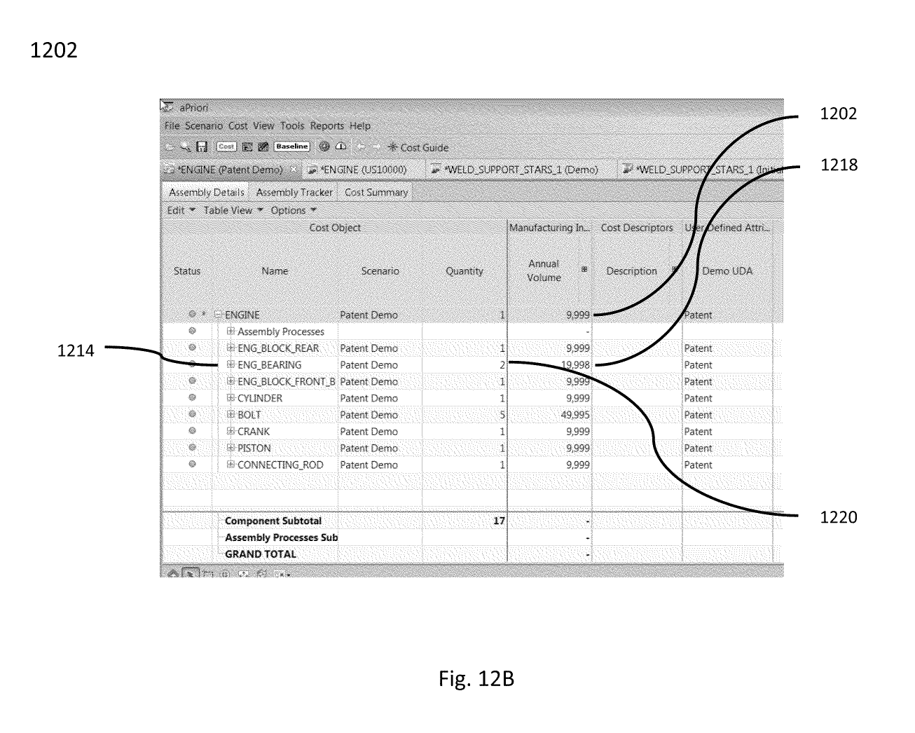

In embodiments, it may be possible to easily propagate a change in input at the top level to all underlying assemblies, components, and the like where the change may comprise a change in volume, virtual production environment, batch size, and the like. In embodiments, a change at the top level may be rolled down to underlying children, components and assemblies, while taking into account the number of each subassembly and component contributing to the top level assembly. In embodiments, a quantity may be associated with each child or sub assembly which makes up the top level assembly and when changes to volume are made at the top level the quantity of a sub assembly may be used to recalculate the appropriate volume of subassemblies needed support the new volume for the top level assembly. In an illustrative and non-limiting example, FIG. 12A shows a screenshot of an input screen 1200 where a change in volume 1202 has been made to the top level assembly 1102 and a dialog box 1204 may allow a user to “copy assembly inputs to children” 1208. A second dialog box 1210 is shown which may enable a user to specify which inputs are to be propagated from the top level to the underlying, children, components, assemblies and the like. Referring to FIG. 12B, a screenshot of a user input screen 1212 is shown where the initial change in volume 1202 at the top level assembly has been propagated to the underlying components and assemblies (e.g. children). The change in the top level volume 1202 at the top level was propagated to the assembly's children resulting in new volumes for the underlying assemblies. For the subassembly “ENG_BEARING” 1214, a new volume 1218 has been calculated where the new volume 1218 represents twice the new top level volume 1202 of the top level assembly as the top level assembly is comprised of a quantity of ENG_BEARING” 1220 equal to two in a single top level assembly.

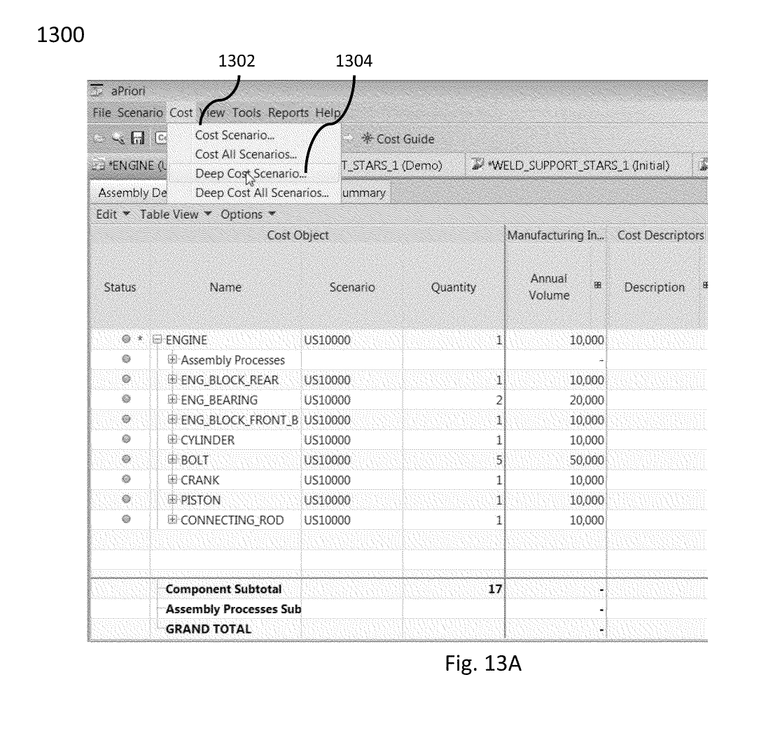

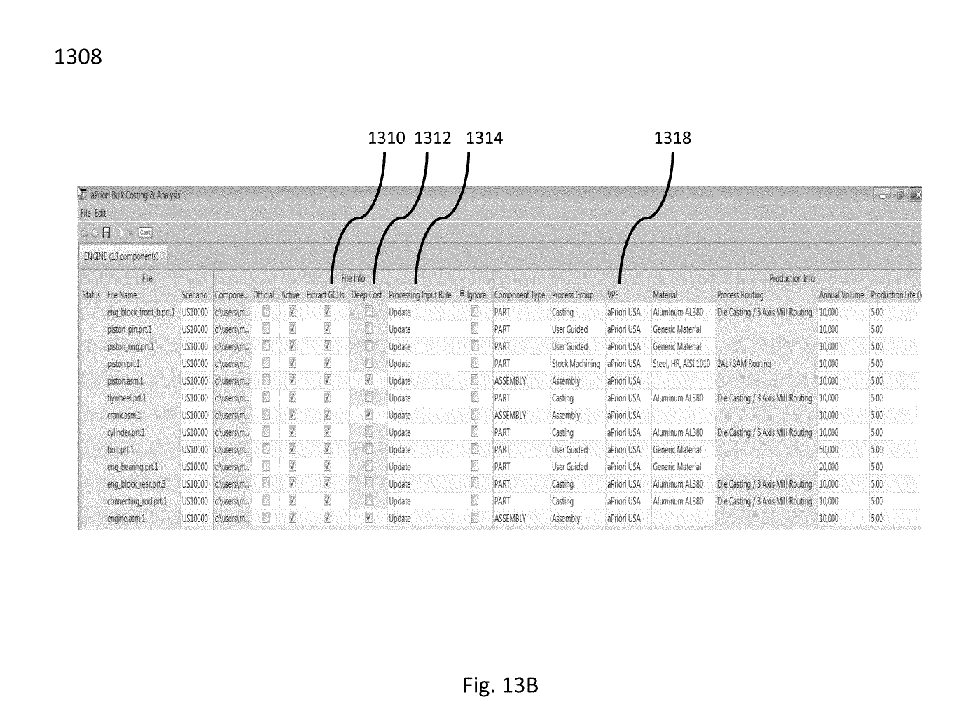

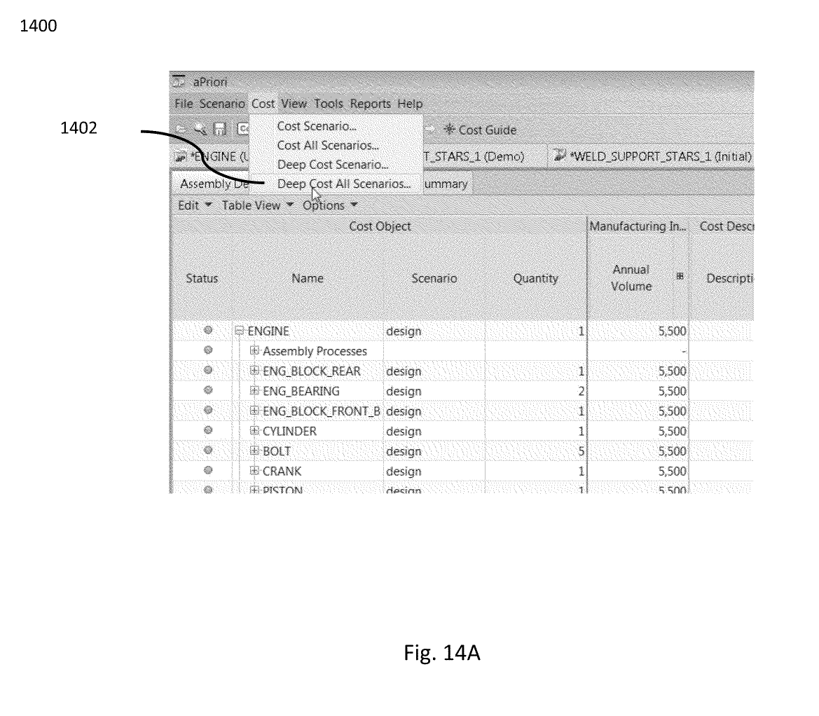

In embodiments, it may be possible to do “deep costing” of a scenario where the cost of all components and subassemblies used in a given assembly and scenario may be automatically updated in a background process leaving the application free for other work. In embodiments, a user input screen may be provided allowing a user to quickly customize the “bulk costing” for attributes such as: whether to update each individual component; whether to re-extract geometry from a CAD file for an individual component; and the like. In an illustrative and non-limiting example, FIG. 13A shows a screenshot of a user input screen 1300 showing a dialog box 1302 with an option to “Deep Cost Scenario” 1304. Referring to FIG. 13B a snapshot of an illustrative user input screen 1308 is shown comprising details for a top level assembly such as sub assemblies and components and means for a user to specify attributes such as “Extract GCD” 1310, “Deep Cost” 1312, Update 1314, Virtual Production Environment 1318, and the like for each underlying component, assembly and the like.

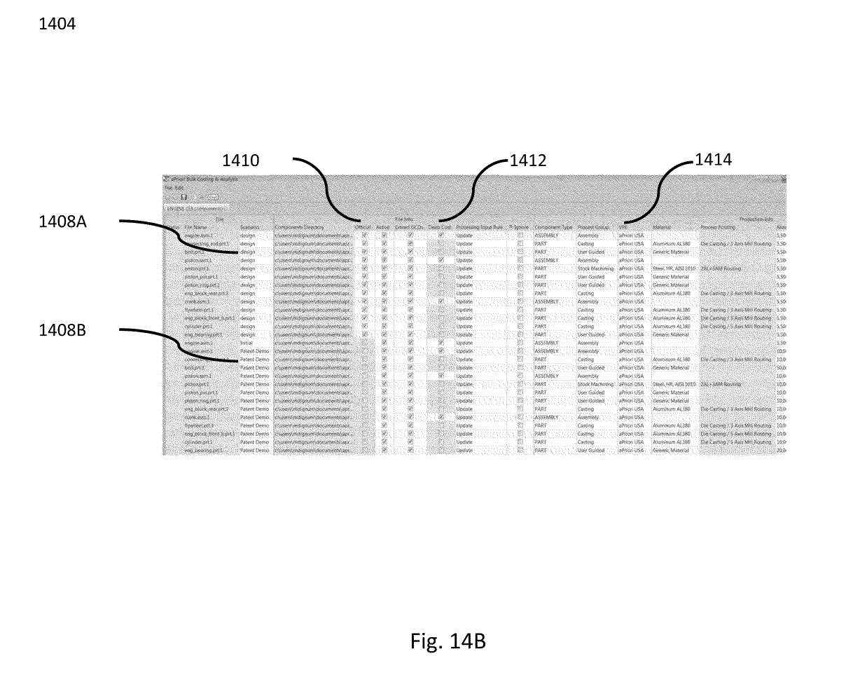

In embodiments, it may be possible to easily recalculate cost estimates across all scenarios related to a particular top-level assembly. In an illustrative and non-limiting example, data related to a virtual production environment, such as labor rates and the like, may be updated and it may be desirable to roll this new information into all the cost estimate scenarios associated with a particular product, assembly, or the like. Referring to FIG. 14A, an illustrative example of a screen shot of an input screen 1400 is shown comprising information regarding a specific scenario with a drop down menu enabling the user to select an option of “deep cost all scenarios” 1402. Selection of this option may result in a summary screen, an example of which is shown in FIG. 14B, showing multiple scenarios 1408 facilitating the selection of the “official” scenario 1410, which items to “deep cost” 1412, selection of virtual production environments 1414, and the like. In an illustrative and non-limiting example illustrated in FIGS. 14A and 14B, a user reviewing the design scenario for the “Engine” assembly a user may select to “deep cost” all scenarios associated with the “Engine” assembly. FIG. 14B shows an example screen shot of a user input screen 1418 showing details for a plurality of scenarios 1408A 1408B with options for specifying Virtual Production Environment, VPE, 1414, Official Cost 1410, Deep Cost 1412, Extract Geometric Cost Drivers (GCD) 1418, and the like. In embodiments, Official Cost 1410 may allow a user to select the official or default cost scenario used when rolling the cost estimate for a component, assembly or the like into a larger assembly. In embodiments, a user may have the option of whether to roll up the costs at the official level, deep cost an assembly at the level of the individual components, Deep Cost 1412, start from the CAD model and re-extract the Geometric Cost Drivers 1418, and the like.

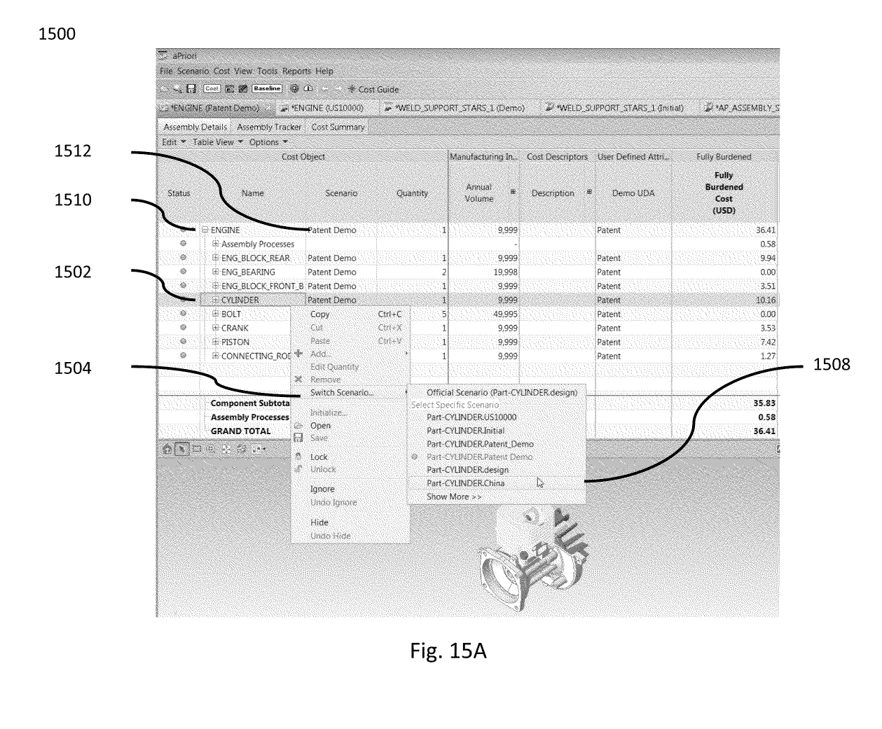

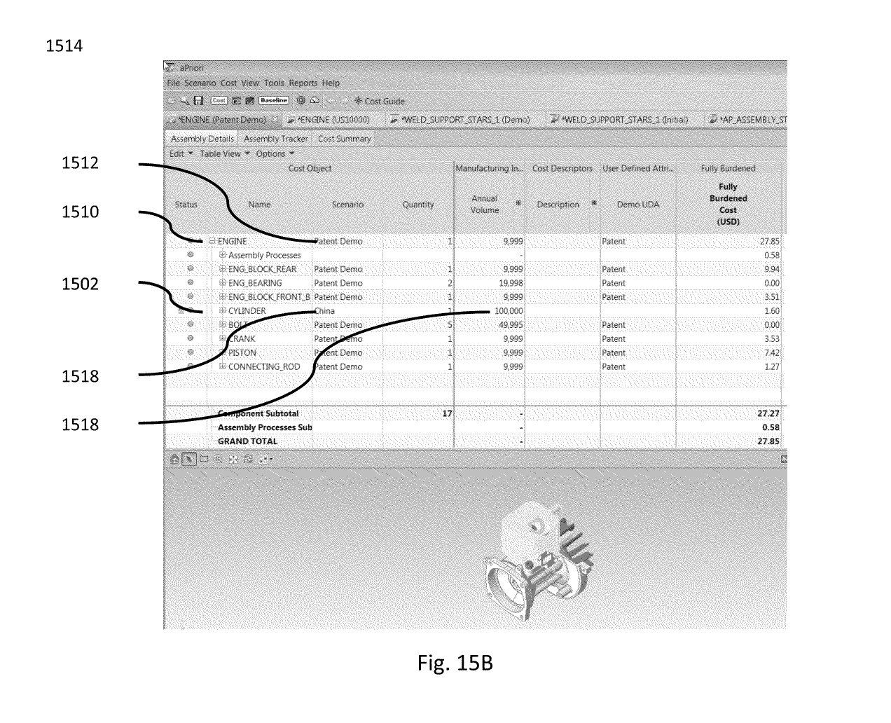

In embodiments, a user may change the scenario associated with a specific subassembly within an alternate scenario for a higher level component. Referring to FIG. 15A, an illustrative example of a screen shot of a user input screen 1500 may be seen showing the selection of an assembly's subassembly 1502 and a drop down menu option to “switch scenario” 1404 with a list of extant scenarios 1508. Referring to FIG. 15B, an illustrative example of a screen shot of a user input screen 1510 is shown illustrating the “Patent Demo” scenario 1512 for the “Engine” assembly 1510. In this example, the “Cylinder” subassembly 1502 now indicates a “China” scenario 1518. In an illustrative example, a user may wish to estimate the cost for a plurality of scenarios. However, in all scenarios the user may wish to use a cylinder assembly 1502 made according to the China Scenario 1518 for a variety of reasons such as local expertise, a common part made at higher volumes than called for by a single product or assembly, and the like.

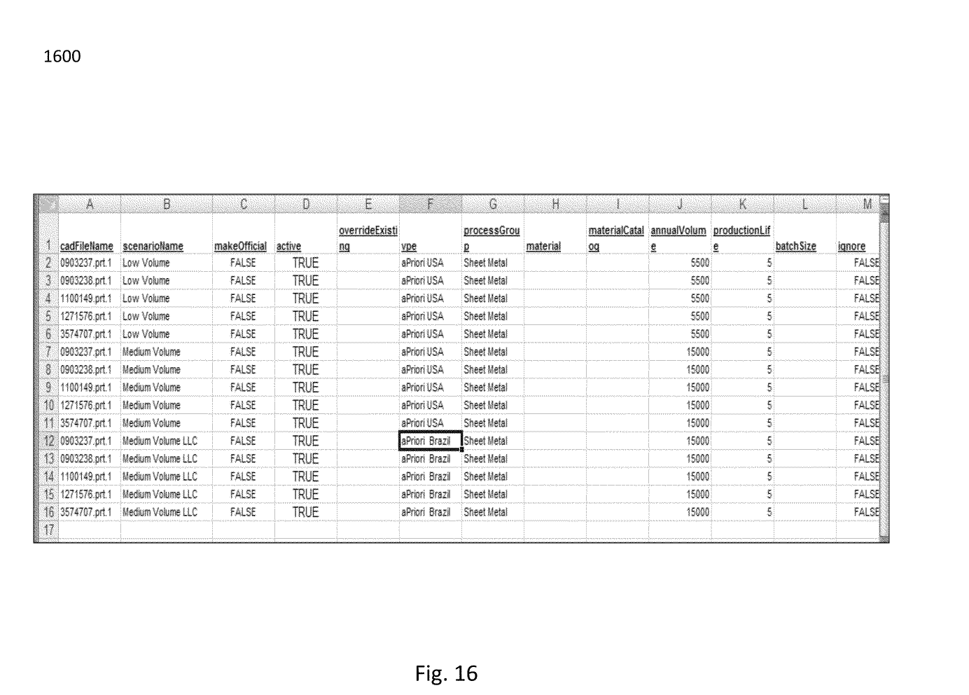

In embodiments, it may be possible to automatically load a standard set of scenario options from a design file and run the multiple cost estimation scenarios in the background, bulk costing. Referring to FIG. 16, an illustrative example of a spreadsheet 1600 is shown where columns may comprise options representative of those accessible from the user screens accessed through deep costing and rows may represent different cad volumes and associated scenarios. In this way, it may be possible to specify and run a number of scenarios quickly without opening and entering each scenario individually. In an illustrative and non-limiting example, a manufacture may have a standard practice of costing new assemblies at a few different volumes. These standard scenarios may be easily run using the ability to load a plurality of assembly scenarios from an external spreadsheet, structured file, or the like.

In embodiments, it may be possible to estimate the cost for an assembly and then parse those costs to identify subsets of components based on their cost contribution such as identifying the top ten components having the highest cost per mass, the top ten components with the longest machine time, and the like.

In embodiments, it may be possible to import a bill of materials, BOM, from an external source where the BOM is stored in a common file format such as comma-separated values (CSV) and the like. In embodiments, the system may generate new parts and assembly components from the imported BOM. In embodiments, the BOM may add hierarchical structure to previously created rollups of components. In embodiments, it may be possible to configure how input BOM data is incorporated such as replace, update and skip when there are two or more components or scenarios with the same name.

In some instances, the system may automatically determine the draw direction for a component that is made by molding. Molds are also referred to as tools. Examples of processing using such molds or tools include, but are not limited to, plastic injection molding, blow molding or thermoforming. Draw direction principally applies to orienting the part and the mold so that the mold can be most easily and economically made. Thus, if the part resembles an open tub, or box, the mold would likely be made with the top of the tub oriented at the bottom or top of the tool by which it is molded. As with all tools, in general, the simpler the process, the more economical. The more complicated the process, the more expensive the process and the mold. Thus, if the molded part requires a number of features, the mold must somehow provide for these features. Examples of features in parts include, but are not limited to, undercuts, openings, grilles and mating portions. To achieve these features, the tool may have to include side pulls and lifters, for example. Some features, such as openings, may be added later via secondary processes, such as drilling, but that also adds cost to the finished parts.

Determining a desirable draw direction for the part provides a good start for the costing task. A plurality of candidate draw directions may be identified such as cardinal directions, directions aligned with one or more of the largest surface areas, and the like. In one embodiment, a volume of undercuts may be estimated for each candidate draw direction. For each candidate draw direction, an undercut is defined as region of the part that is not visible along a line of sight in the candidate draw direction and in a line opposite to the candidate draw direction. One way to estimate the volume of undercuts is to digitally cast many “rays” or lines parallel to the candidate draw direction and to determine algorithmically how many of the lines are bound by part from both sides. A smaller volume of undercuts is preferred and the smaller volumes are typically associated with lower costs.

In one embodiment, for each candidate draw direction, a value may be assigned to each of a plurality of features such as: number and volume of undercuts, number of holes and grilles aligned with the draw direction, mounting holes aligned with the draw direction, part height along the draw direction, flatness of the parting line, areas of surfaces aligned with the draw direction, and the like. The values for each candidate draw direction may be summed according to a weighted formula. In some embodiments, the values associated with each feature may be normalized to a value between 0 and 1. In some embodiments, the weighting associated with each value in the weighted formula may be variable and user adjustable. In some embodiments, the weighting associated with each value may be determined empirically. The resulting sum or “weight” for a given candidate draw direction may be compared with the “weight” associated with the other candidate draw directions. The candidate draw direction having the largest “weight” may be selected as the preferred draw direction. In an illustrative and non-limiting example, flatter parting lines may be preferred over parting lines that have positive vertical height, and thus, flatter parting lines may receive a higher value. In some cases, holes may be less costly to manufacture if they are aligned parallel with the draw direction. Therefore, in some embodiments, draw direction value may increase with the numbers of holes aligned with that draw direction. In some cases, a higher value may be placed on mounting holes relative to other types of holes. Draw direction value may increase with a decrease in part height, and corresponding mold box height, along the draw direction. Typically, box height along the draw direction determines travel distance required to open the mold. A shorter box height may decrease the travel needed by the mechanism to open the mold and correspondingly, the time spent on opening the mold for each part may decrease. Also, a shorter box height may improve how well the mold fits into the manufacturing apparatus. Thus, in this embodiment, draw direction value may increase with a decrease in part height. Draw direction value may increase with the surface area “aligned” with the draw direction where “aligned” may mean such directions as: a draw direction parallel to curved walls; a draw direction orthogonal to planes, and the like.

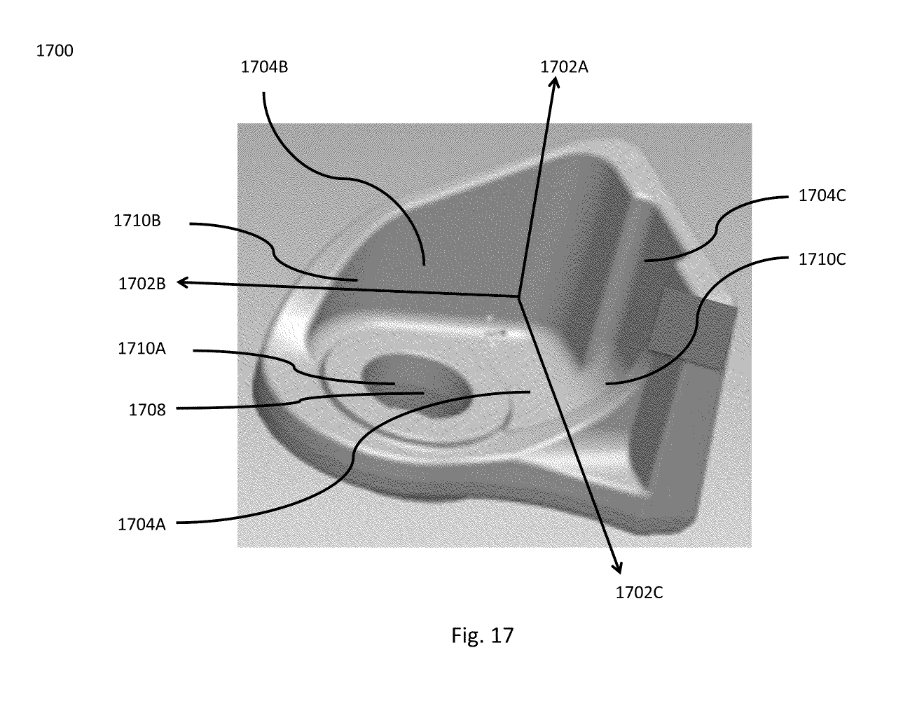

In an illustrative and non-limiting example of the selection of draw direction, FIG. 17 shows an example of a part to be analyzed for selection of draw direction 1700 comprising three potential draw directions 1702A-C, surfaces 1704A-C, a hole 1708, and 3 examples of undercuts 1710A-C. Potential draw direction 1702A is aligned with the hole 1708 and so may have a higher value on that parameter relative to the other directions. There are no undercuts associated with potential draw direction 1702A and it is aligned with walls 1704B and 1704C. Potential draw direction 1702B has two undercuts: one is inside the hole 1710A; and the second one is between curved walls on the left and right side of the image 1710B. Potential draw direction 1702B is aligned with walls 1704A and 1704B and produces a non-flat parting line, because the line needs to touch the ring surrounding the hole underneath the part, and the top of the right wall of the part. Potential draw direction 1702C also has two associated undercuts: one is inside the hole 1710A; and the other goes between front and back walls 1710C. It is aligned with walls 1704A and 1704C and produces a non-flat parting line, because it needs to touch the ring around the hole underneath the part, and the top of the back wall of the part. Given the various factors associated with the three potential draw directions 1702A-C, the preferred draw direction is 1702A as it has no undercuts, a flat parting line, a large aligned surface area 1704B and 1704C and a hole 1708.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

All documents referenced herein are hereby incorporated by reference.

What is claimed is:

1. A computer-implemented system, for estimating a cost for an assembly, the system comprising:
a cost estimation module stored on a non-transitory computer readable medium and using a microprocessor adapted to:
identify a plurality of parts, the parts comprising at least one of components and subassemblies for the assembly;
calculate a cost of each identified component;
calculate a cost of each identified subassembly;
calculate a cost of assembling each of the components and subassemblies requiring assembling; and
calculate a total cost of parts and a total cost of assembling for the assembly.

2. The system of claim 1 further comprising a manufacturing analysis module stored on a non-transitory computer readable medium and using the microprocessor adapted to represent a plurality manufacturing scenarios for a given assembly; and
a second cost estimation module stored on a non-transitory computer readable medium and using a microprocessor adapted to enable a user to concurrently run cost estimations for the plurality of manufacturing scenarios associated with a given assembly.

3. The system of claim 1 wherein the cost estimation module is further adapted to calculate the cost of each identified component at each of a plurality of separate manufacturing facilities.

4. The system of claim 1 wherein the cost estimation module is further adapted to calculate the cost of each identified subassembly at each of a plurality of separate manufacturing facilities.

5. The system of claim 1 wherein the cost estimation module is further adapted to calculate the cost of assembling each of the components or subassemblies requiring assembly at each of a plurality of separate facilities.

6. The system of claim 1 wherein the cost estimation module is further adapted to estimate a quantity of the assembly, and wherein changing the estimated quantity causes a change in the step of calculating a cost of at least one identified component or in calculating a cost of assembling at least one of the components or subassemblies, thus changing the calculated total cost for the changed estimated quantity.

7. The system of claim 6, wherein the estimated quantity is selected from the group consisting of a batch quantity and an annual volume.

8. The system of claim 1, wherein the cost estimation module is further adapted to store information regarding manufacturing and assembly costs for a plurality of components and a plurality of subassemblies useful for the estimating the cost of the assembly, the information selected from the group consisting of: available equipment, manufacturing costs, material costs, labor costs, transportation costs, overhead costs and energy costs.

9. A system for estimating a cost for an assembly, the system comprising:
a cost estimation module stored on a non-transitory computer readable medium and using a microprocessor adapted to:
identify a plurality of parts, the parts comprising at least one of components and subassemblies for the assembly;
calculate a cost of each identified component, wherein calculating the cost of at least one identified component comprises calculating a cost to manufacture the at least one identified component from a cost of time and materials;
calculate a cost of each identified subassembly;
calculate a cost of assembling each of the components and subassemblies requiring assembling; and
calculate a total cost of parts and a total cost of assembling for the assembly.

10. The system of claim 9, wherein calculating a cost to manufacture the at least one identified component from a cost of time and materials may comprise a two-model cost estimation.

11. The system of claim 10, wherein the cost estimation module is further adapted to calculate the cost to manufacture the at least one identified component at each of a plurality of separate manufacturing facilities.

12. The system of claim 9, wherein the cost estimation module is further adapted calculate the cost of each identified subassembly at each of a plurality of separate manufacturing facilities.

13. The system of claim 9, wherein the cost estimation module is further adapted calculate the cost of assembling each of the components or subassemblies requiring assembly at each of a plurality of separate facilities.

14. The system of claim 9 further comprising a manufacturing analysis module stored on a non-transitory computer readable medium and using a microprocessor adapted to:
enable a user to develop a plurality manufacturing scenarios for a given assembly, wherein the cost estimation module enables a user to concurrently run cost estimations for the plurality of manufacturing scenarios associated with a given assembly.

15. A system for estimating a cost for a specified quantity of an assembly, the system comprising:
a cost estimation module stored on a non-transitory computer readable medium and using a microprocessor adapted to:
identify a plurality of parts, the parts comprising at least one of components and subassemblies for the assembly;
calculate a cost of each identified component;
calculate a cost of each identified subassembly;
calculate a cost of assembling each of the components and subassemblies requiring assembling; and
calculate a total cost of parts and a total cost of assembling for the particular quantity of the assembly,
wherein the total cost includes estimates for the specified quantity of the assembly and wherein the cost of at least one of the identified components, the cost of at least one of the identified subassemblies and the cost of assembling each of the components and subassemblies depends on the specified quantity.

16. The system of claim 15, wherein the microprocessor is further adapted to change the specified quantity, and wherein calculating the total cost of parts and the total cost of assembly for the changed specified quantity requires recalculating at least one cost selected from the group consisting of the cost of an identified component, the cost of an identified subassembly and the cost of assembling at least one component or subassembly requiring assembling.

17. The system of claim 15, wherein the cost of at least one identified component is calculated by a two-model CAD method.

18. The system of claim 15, wherein at least one identified component is a gear and wherein the cost of the gear is calculated with an automatic gear costing system that includes a step of automatically identifying a geometric pattern.

19. The system of claim 15, wherein at least one identified part is a molded part or a casting and wherein the cost of a tool for manufacturing the molded part or casting is calculated with a program for determining a low-cost draw direction for the tool.

20. The system of claim 15, wherein the specified quantity is selected from the group consisting of a batch quantity and an annual volume.
